(19) United States
(12) Patent Application Publication
(10) Pub. No.: US 2009/0053937 A1
(43) Pub. Date: Feb. 26, 2009

(54) STACKABLE COMPOSITE POWER CONNECTOR

(75) Inventors: Yung-Hung Tsou, Taoyuan (TW); Tung-Hung Hsieh, Taoyuan (TW)

Correspondence Address: AUSTIN RAPP & HARDMAN, 15 WEST SOUTH TEMPLE, SUITE 900, SALT LAKE CITY, UT, 84101, US

(73) Assignee: Delta Electronics, Inc., Taoyuan (TW)

(21) Appl. No.: 12/034,262

(22) Filed: Feb. 20, 2008

(30) Foreign Application Priority Data
Aug. 22, 2007 (TW) 096131102

(51) Int. Cl. H01R 25/00

(52) U.S. Cl. 439/638

(57) ABSTRACT

The present invention relates to a composite power connector. The composite power connector includes multiple first connecting units arranged in a stack form, multiple second connecting units arranged in a stack form and a fastening element. Each first connecting unit includes a first end coupled with an electric wire, a second end formed as an insertion terminal to be coupled with a corresponding second connecting unit, a first surface having a first perforation and a second surface having a second perforation corresponding to the first perforation. A channel is defined by the first perforation and the second perforation. The fastening element penetrates through the channels of the multiple first connecting units for combining and fixing the multiple first connecting units with each other.

### FIELD OF THE INVENTION

The present invention relates to a composite power connector, and more particularly to a stackable composite power connector.

### BACKGROUND OF THE INVENTION

Various connectors have been broadly used to deliver electric power from power-supplying devices to power-receiving devices. Take an uninterruptible power supply (UPS) apparatus for example. A connector is used to connect the UPS apparatus and a power-receiving device. When the utility power is normally provided, the electronic circuit of the UPS apparatus converts the utility power from alternating current (AC) to direct current (DC) for supplying the power-receiving device and charging a battery contained therein. When the utility power is unavailable, the uninterrupted power supply system converts the electric power stored in the battery so as to continuously supply power to the power-receiving device and avoid power failure.

Generally, an uninterruptible power supply (UPS) system includes a plurality of UPS apparatuses. Each UPS apparatus principally includes a battery and a circuit board. The battery and the circuit board are electrically connected with each other by a connector and two electrical wires. By means of the circuit board, the utility power may be converted from alternating current (AC) to direct current (DC) for supplying the power-receiving device and charging the battery.

The conventional power connector assembly includes a first connecting unit and a second connecting unit. The first connecting unit and the second connecting unit have respective insertion terminals, which may be coupled with each other.

Generally, a first conductive pin is received within the first insertion terminal of the first connecting unit. The first conductive pin is substantially a tube member having an end coupled to an electric wire. The second insertion terminal of the second connecting unit has a second conductive pin corresponding to the first conductive pin. The second conductive pin is substantially a post member having an end coupled to another electric wire. When the post member (i.e. the second conductive pin) is inserted into the tube member (i.e. the first conductive pin), the first connecting unit is electrically connected with the second connecting unit.

In a case that the UPS apparatus has a plurality of batteries, the wire linkages become complicated because many power connector assemblies are required. For example, the first connecting units and the second connecting units of respective power connector assemblies need to be coupled with each other. Therefore, the electric wires are in a mess and occupy a lot of space.

In views of the above-described disadvantages resulted from the prior art, the applicant keeps on carving unflaggingly to develop a stackable composite connector according to the present invention through wholehearted experience and research.

### SUMMARY OF THE INVENTION

It is an object of the present invention to provide a stackable composite power connector, in which the electric wires are arranged orderly and thus the space utilization is enhanced.

In accordance with an aspect of the present invention, there is provided a composite power connector. The composite power connector includes multiple first connecting units arranged in a stack form, multiple second connecting units arranged in a stack form and a fastening element. Each first connecting unit includes a first end coupled with an electric wire, a second end formed as an insertion terminal to be coupled with a corresponding second connecting unit, a first surface having a first perforation and a second surface having a second perforation corresponding to the first perforation. A channel is defined by the first perforation and the second perforation. The fastening element penetrates through the channels of the multiple first connecting units for combining and fixing the multiple first connecting units with each other.

In accordance with an aspect of the present invention, there is provided a composite power connector. The composite power connector includes multiple first connecting units, a first fastening element, multiple second connecting units and a second fastening element. The multiple first connecting units are arranged in a stack form. Each first connecting unit includes a first end coupled with a first electric wire, a second end formed as a first insertion terminal, a first surface having a first perforation and a second surface having a second perforation corresponding to the first perforation. A first channel is defined by the first perforation and the second perforation of the first connecting unit. The first fastening element penetrates through the first channels of the multiple first connecting units for combining and fixing the multiple first connecting units with each other. The multiple second connecting units are arranged in a stack form. Each second connecting unit includes a first end coupled with a second electric wire, a second end formed as a second insertion terminal to be coupled with a corresponding first insertion terminal of the first connecting unit, a first surface having a first perforation and a second surface having a second perforation corresponding to the first perforation. A second channel is defined by the first perforation and the second perforation of the second connecting unit. The second fastening element penetrates through the second channels of the multiple second connecting units for combining and fixing the multiple second connecting units with each other.

The above contents of the present invention will become more readily apparent to those ordinarily skilled in the art after reviewing the following detailed description and accompanying drawings, in which:

### BRIEF DESCRIPTION OF THE DRAWINGS

FIG. 1(a) is a schematic front view of a power connector assembly according to a preferred embodiment of the present invention;

FIG. 1(b) is a schematic backside view of the power connector assembly in FIG. 1(a); and

FIG. 2 is a schematic view illustrating a stackable composite power connector of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

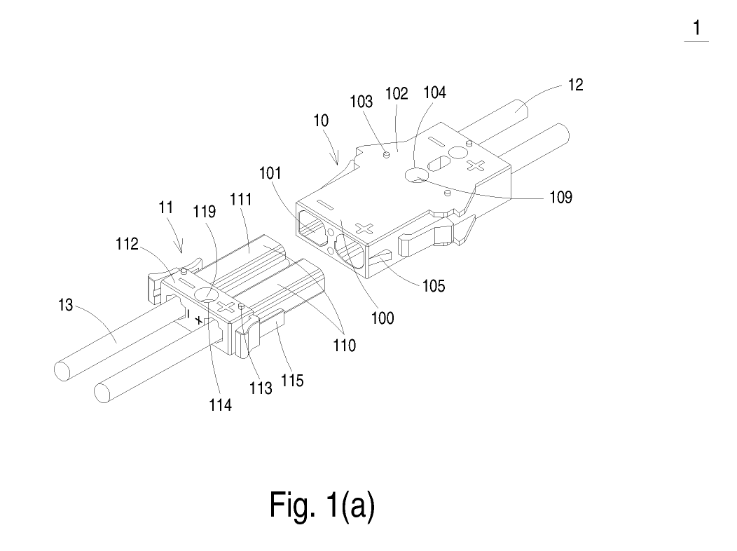

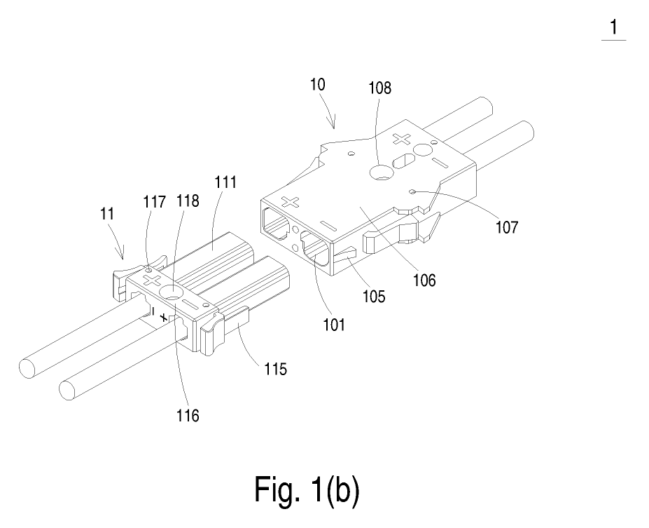

Referring to FIGS. 1(a) and 1(b), schematic front and backside views of a power connector assembly according to a preferred embodiment of the present invention are respectively illustrated. As shown in FIG. 1(a), the power connector assembly 1 principally includes a first connecting unit 10 and a second connecting unit 11. An end of the first connecting unit 10 is electrically connected to a power-supplying device (not shown) such as a battery of a UPS apparatus via electric wires 12. The other end of the first connecting unit 10 is formed as an insertion terminal 100 to be coupled with the second connecting unit 11. In this embodiment, the insertion terminal 100 of the first connecting unit 10 has two receptacles 101 and two conductive pins (not shown). The conductive pins of the first connecting unit 10 are received in the receptacles 101 and coupled with the electric wires 12. An end of the second connecting unit 11 is electrically connected to a power-receiving device such as a circuit board through electric wires 13. The other end of the second connecting unit 11 is coupled with the insertion terminal 100 of the first connecting unit 10. In this embodiment, the insertion terminal 110 of the second connecting unit 11 includes two tube structures 111 and two conductive pins (not shown). The conductive pins of the second connecting unit 11 are received in the tube structures 111 and coupled with the electric wires 13. The locations of the tube structures 111 are faced to those of the receptacles 101. After the tube structures 111 of the second connecting unit 11 may be inserted into the receptacles 101 of the first connecting unit 10, the power-supplying device (e.g. the battery) is electrically connected with the power-receiving device (e.g. the circuit board) through the conductive pins and the electric wires 12 and 13.

Please refer to FIGS. 1(a) and 1(b). The first connecting unit 10 has a first surface 102 and a second surface 106. A first perforation 104 is formed in the middle of the first surface 102, and a second perforation 108 corresponding to the first perforation 104 is formed in the second surface 106. A channel 109 is defined by the first perforation 104 and the second perforation 108.

In some embodiments, one or more first retaining structures 103 are formed on the first surface 102, and one or more second retaining structures 107 are formed on the second surface 106 corresponding to the first retaining structures 103. For example, the first retaining structures 103 and the second retaining structures 107 are salients and indentations, respectively. The number and the locations of the first retaining structures 103 are determined according to the manufacturer's design. In addition, the number and the locations of the second retaining structures 107 are determined according to the first retaining structures 103.

Likewise, the second connecting unit 11 has a first surface 112 and a second surface 116. A first perforation 114 is formed in the middle of the first surface 112, and a second perforation 118 corresponding to the first perforation 114 is formed in the second surface 116. A channel 109 is defined by the first perforation 104 and the second perforation 118. In some embodiments, one or more first retaining structures 113 are formed on the first surface 112, and one or more second retaining structures 117 are formed on the second surface 116 corresponding to the first retaining structures 113. For example, the first retaining structures 113 and the second retaining structures 117 are salients and indentations, respectively. The number and the locations of the first retaining structures 113 are determined according to the manufacturer's design. In addition, the number and the locations of the second retaining structures 117 are determined according to the first retaining structures 113.

Please refer to FIGS. 1(a) and 1(b) again. Two first engaging structures 105 are respectively formed on bilateral sides of the first connecting unit 10. In addition, two second engaging structures 115 are respectively formed on bilateral sides of the second connecting unit 11 corresponding to the first engaging structures 105. As a consequence, the first connecting unit 10 is securely coupled with the second connecting unit 11 when the second engaging structures 115 are engaged with the first engaging structures 105.

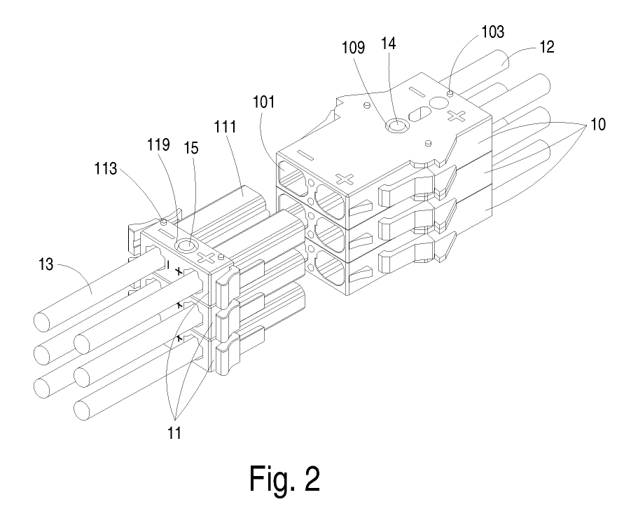

In accordance with a specific feature of the present invention, multiple power connector assemblies may be stacked as a stackable composite connector. FIG. 2 is a schematic view illustrating a stackable composite power connector of the present invention. Please refer to FIG. 1(a), FIG. 1(b) and FIG. 2. For stacking multiple first connecting units 10, the first retaining structures 103 on the first surface 102 of each first connecting unit 10 are engaged with the second retaining structures 107 on the second surface 106 of the adjacent first connecting unit 10. As a consequence, the multiple first connecting units 10 are arranged in a stack form. Meanwhile, the channels 109 of the multiple first connecting units 10 are aligned with each other. By penetrating a first fastening element 14 such as a screw/nut assembly or a locking member through these channels 109, these first connecting units 10 are combined together. Under this circumstance, the multiple first connecting units 10 are arranged in a stack form by means of the first retaining structures 103, the second retaining structures 107 and the first fastening element 14.

For stacking multiple second connecting units 11, the first retaining structures 113 on the first surface 112 of each second connecting unit 11 are engaged with the second retaining structures 117 on the second surface 116 of the adjacent second connecting unit 11. As a consequence, the multiple second connecting units 11 are arranged in a stack form. Meanwhile, the channels 119 of the multiple second connecting units 11 are aligned with each other. By penetrating a second fastening element 15 such as a screw/nut assembly or a locking member through these channels 119, these second connecting units 11 are combined together. Under this circumstance, the multiple second connecting units 11 are arranged in a stack form by means of the first retaining structures 113, the second retaining structures 117 and the second fastening element 15.

Since the first connecting units 10 and the second connecting units 11 are both assembled in stack forms, the insertion terminals of the first connecting units 10 and the insertion terminals of the second connecting units 11 may be coupled together without difficulty, thereby making electrical connection between the power-supplying device and the power-receiving device through the conductive pins and the electric wires 12 and 13. Moreover, since the electric wires 12 and 13 are arranged orderly, the space utilization is enhanced.

From the above description, the power connector assembly and the stackable composite connector of the present invention may be employed to connect a power-supplying device with a power-receiving device. Since the first connecting units and the second connecting units are both assembled in stack forms and fixed by the retaining structures and the fastening elements, the wire linkage become convenient. Moreover, since the electric wires are arranged orderly, the space utilization is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A composite power connector comprising multiple first connecting units arranged in a stack form, multiple second connecting units arranged in a stack form and a fastening element, each first connecting unit including a first end coupled with an electric wire, a second end formed as an insertion terminal to be coupled with a corresponding second connecting unit, a first surface having a first perforation and a second surface having a second perforation corresponding to said first perforation, wherein a channel is defined by said first perforation and said second perforation, and said fastening element penetrates through said channels of said multiple first connecting units for combining and fixing said multiple first connecting units with each other, wherein each of said first connecting units has receptacles and each of said second connecting units has tube structures corresponding to said receptacles.

2. (canceled)

3. (canceled)

4. The composite power connector according to claim 1 wherein said fasting element includes a screw/nut assembly.

5. The composite power connector according to claim 1 wherein said first surface of each first connecting unit includes a plurality of first retaining structures.

6. The composite power connector according to claim 5 wherein said second surface of each first connecting unit includes a plurality of second retaining structures corresponding to said first retaining structures, and said first retaining structure on said first surface of each first connecting unit are engaged with said second retaining structures on said second surface of the adjacent first connecting unit.

7. The composite power connector according to claim 1 wherein two first engaging structures are respectively formed on bilateral sides of each first connecting unit.

8. The composite power connector according to claim 7 wherein two second engaging structures are respectively formed on bilateral sides of each second connecting unit to be engaged with said first engaging structures.

9. A composite power connector comprising:
multiple first connecting units arranged in a stack form, each first connecting unit including receptacles, a first end coupled with a first electric wire, a second end formed as a first insertion terminal, a first surface having a first perforation and a second surface having a second perforation corresponding to said first perforation, wherein a first channel is defined by said first perforation and said second perforation of said first connecting unit;
a first fastening element penetrating through said first channels of said multiple first connecting units for combining and fixing said multiple first connecting units with each other;
multiple second connecting units arranged in a stack form, each second connecting unit including tube structures corresponding to said receptacles, a first end coupled with a second electric wire, a second end formed as a second insertion terminal to be coupled with a corresponding first insertion terminal of said first connecting unit, a first surface having a first perforation and a second surface having a second perforation corresponding to said first perforation, wherein a second channel is defined by said first perforation and said second perforation of said second connecting unit; and
a second fastening element penetrating through said second channels of said multiple second connecting units for combining and fixing said multiple second connecting units with each other.

10. (canceled)

11. (canceled)

12. The composite power connector according to claim 9 wherein said first fasting element includes a screw/nut assembly.

13. The composite power connector according to claim 9 wherein said second fasting element includes a screw/nut assembly.

14. The composite power connector according to claim 9 wherein said first surface of each first connecting unit includes a plurality of first retaining structures.

15. The composite power connector according to claim 14 wherein said second surface of each first connecting unit includes a plurality of second retaining structures corresponding to said first retaining structures, and said first retaining structure on said first surface of each first connecting unit are engaged with said second retaining structures on said second surface of the adjacent first connecting unit.

16. The composite power connector according to claim 9 wherein said first surface of each second connecting unit includes a plurality of first retaining structures.

17. The composite power connector according to claim 16 wherein said second surface of each second connecting unit includes a plurality of second retaining structures corresponding to said first retaining structures, and said first retaining structure on said first surface of each second connecting unit are engaged with said second retaining structures on said second surface of the adjacent second connecting unit.

18. The composite power connector according to claim 9 wherein two first engaging structures are respectively formed on bilateral sides of each first connecting unit.

19. The composite power connector according to claim 18 wherein two second engaging structures are respectively formed on bilateral sides of each second connecting unit to be engaged with said first engaging structures.
